(19) United States
(12) Patent Application Publication
(10) Pub. No.: US 2002/0107910 A1
(43) Pub. Date: Aug. 8, 2002

(54) Client/server two-way communication system framework under HTTP protocol

(76) Inventor: Yan Zhao, Falls Church, VA (US)

Correspondence Address: JOHNSON & ASSOCIATES, PO BOX 90698, AUSTIN, TX, 78709-0698, US

(21) Appl. No.: 09/776,478

(22) Filed: Feb. 2, 2001

(51) Int. Cl. G06F 15/173; G06F 15/16

(52) U.S. Cl. 709/203; 709/238

(57) ABSTRACT

A client/server communication framework and method is provided for facilitating server-initiated communications to one or more clients under HTTP protocol. The communication framework provides a mechanism for an application server to voluntarily send data to an application client.

### FIELD OF THE INVENTION

This invention relates to client/server communication systems under HTTP protocol. In particular, this invention relates to a client/server communication system framework and method for facilitating server-initiated communications and two-way communications under HTTP protocol.

### BACKGROUND OF THE INVENTION

In HTTP protocol-based client/server communication systems, e.g. for web applications, the clients send requests to the servers and the servers reply in response to the requests. For some HTTP based applications, it is desirable for servers to send data to the clients. For example, in a real-time application, a server may generate real-time data for a client. However, under HTTP protocol, a server cannot voluntarily communicate with a client. In addition, HTTP protocol is stateless, meaning continuous two-way communication is not possible. There is therefore a need for an HTTP based client/server communication system framework that allows a server to initiate communications with clients.

### SUMMARY OF THE INVENTION

A communication framework and method is provided for facilitating server-initiated communications between application servers and application clients using HTTP protocol. The method includes the step of providing a communication server that receives notification message data from server-side applications, and enables the data to be delivered to their intended one or more clients. A communication client is provided for generating polling requests to the communications server and distributing the received message data to the intended clients of applications. In response to a polling request from a communication client, the communication server sends back any application message data intended for any of the clients of applications that associated with the polling communication client. Upon receiving notification message data, the communication client parses the data and distributes them to the intended clients of applications. This enables the clients of applications to fetch data from their servers based on instructions from their servers so that a server-initiated communication is performed.

Other objects, features, and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements and in which:

FIG. 1 is a block diagram of an application server and an application client utilizing the communication framework of the present invention.

FIG. 2 is a block diagram of a communication framework for multiple server applications residing in an application server and multiple clients residing in an application client for corresponding applications.

FIG. 3 is a block diagram of a communications framework of the present invention in a multi-site environment.

FIG. 4 is a flowchart illustrating the process of a communication server responding to a communication client polling in the communication framework.

FIG. 5 is a flowchart illustrating the process of a communication server responding to a server application data buffering request.

FIG. 6 is a flowchart illustrating the process of a communication client receiving and handling received data.

### DETAILED DESCRIPTION

The present invention relates to a client/server two-way communication framework under HTTP protocol, which can facilitate server-initiated communications to one or more HTTP clients. The communication framework of the present invention provides a mechanism for server-side applications in an HTTP based application server to voluntarily send data to their clients. An application client can be a generic HTTP client, e.g., a web browser. The communication framework mainly consists of a communication client, a communication server, and a message buffer. The framework is used to send communication initialization or control data for applications in the server to establish connections with their clients, while the communication content data is sent directly between the client and the server of each individual application. This can maintain the componentization for each application, and eliminate bottleneck for the communication framework sharing by all applications in an application server.

For one embodiment of the invention, there is one communication server in each application server. The communication server is used for receiving communication initiation messages (i.e. control data) from one or more server-side applications under the same application server. There may be multiple independent applications residing in the same application server (e.g., a number of web applications under the same web server). The communication server stores messages from the applications into a buffer. There is also one communication client in each application client. The communication client is configured to send a polling request to the communication server at the system startup, and during subsequent operations. If a message that is intended for a polling communication client is stored in the buffer, the communication server will send the intended message to this communication client. The communication client then parses the message and distributes the parsed messages to the clients of corresponding applications. Then, the client for each application can make requests to its own server based on the control data it received. The server of the application can therefore respond with content data and consecutive communication instructions, etc. In this way, the two-way communications between clients and servers of applications are established under HTTP protocol.

As is described in more detail below, the invention may be used with multiple HTTP based application servers, multiple HTTP based application clients, multiple application server clusters, etc.

The present invention may be used in various environments. For example, in a web environment, the application clients may be web clients such as web browsers. The applications servers may be web servers or web application servers. In one embodiment, the invention may be used in a customer relationship management (CRM) environment. One goal in the CRM environment is to integrate web-based CRM applications with traditional customer contact center systems to provide more convenience and responsiveness to customers. A multi-media web collaboration function used in a CRM environment provides customers with agent assisted self-service, which bridges web based customer self-service to traditional live-agent based customer contact center customer service. For web collaboration, a collaboration server, that has to use HTTP protocol to enable the use of a firewall, needs to frequently distribute data from one client to others. The types of information a collaboration server may want to send to its clients include shared web content, collaboration configuration data, etc. The present invention enables the collaboration servers to do their job efficiently. Other examples of applications in a CRM environment that need this communication framework are agent management applications. In an agent management application, where the client is an agent web browser, an agent management application server needs to send messages to the agent such as the messages letting the agent know that there is another task for the agent. The agent can then respond appropriately. In a web-based collaboration application, such as chat and browser sharing, an agent may need to handle web media sessions in different sites, handle multiple media sessions, or handle transferred web sessions from different web sites. Therefore, the communication framework needs to be applied to multiple applications and multiple application server sites.

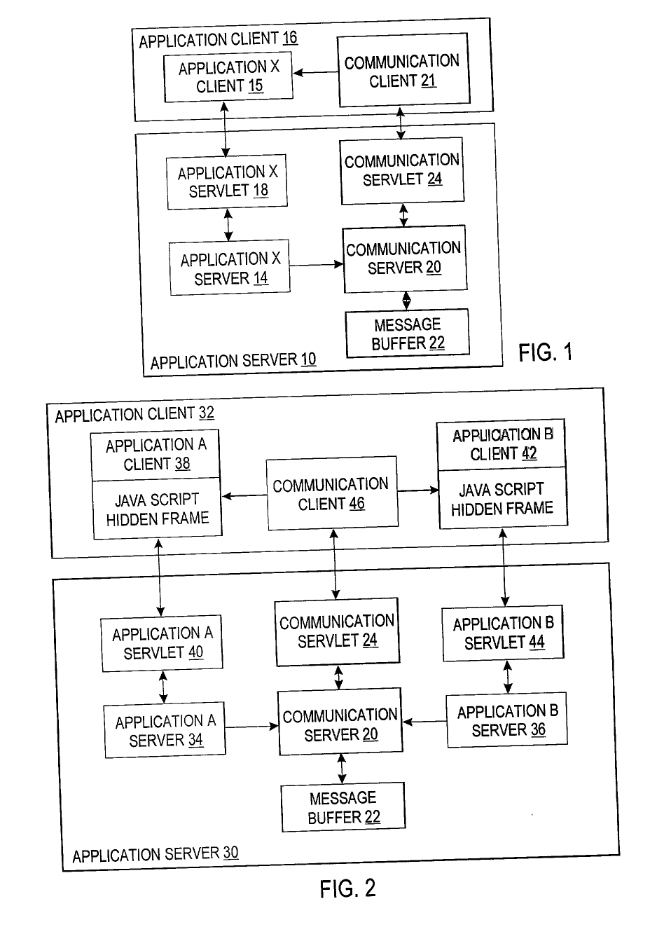

FIG. 1 is a block diagram of an HTTP based application server and an application client utilizing the communication framework of the present invention for its applications to achieve client/server two-way communications. In the example shown in FIG. 1, the application server 10 includes one server-side application, i.e. application X server 14. The application X server 14 communicates, using HTTP protocol, with the application X client 15 in the application client 16. Communications from the application X server 14 to the application X client 15 need to be initialized via the communication framework. The communication framework consists of a communication client 21, a communication server 20, a communication servlet 24, and a message buffer 22.

FIG. 1 shows one communication server 20 in the application server 10. The communication server 20 is configured to receive messages from the applications (e.g., application X server 14) in the application server 10. The messages from the application X server 14 are intended for its specific clients (for example application X client 15 in the application client 16). Since the application X server 14 cannot voluntarily send data to its client under HTTP protocol, a message will be sent via communication server 20 to instruct its client to fetch the data, or the data can be sent via communication framework directly if the data is brief. When the communication server 20 receives a message from the application X server 14, it stores the message in a message buffer 22. The message buffer can be either local or remote to the application server. A remote buffer enables sharing by a cluster of application servers which can be considered as one logical application server. Therefore, the communication server 20 may communicate with the message buffer 22 using either local or remote API. The communication server 20 responds to the communication client 21 requests via communication servlet 24 under HTTP protocol. The servlet is for server-side application retrieval via HTTP protocol, which is a well-known technology. The invention is not limited to the use of servlet technology. The servlet can be replaced by other similar solutions (e.g., CGI programs).

The communication client 21 is configured to poll the communication server 20 at a predetermined time, and after each received message is distributed. When the communication client 21 polls the communication server 20, the communication server 20 checks the contents of the message buffer 22 for messages intended for the corresponding application client 16. If there is a message in the message buffer 22 intended for the application client 16, the communication server 20 sends the message to the communication client 21. The message sent to the communication client 21 will include whatever data the application X server 14 intended to send to the application X client 15. After receiving a communication initiation message, the application X client 15 may send request to the application X server 14 based on instructions in the message. The application X server 14 responses with application data (i.e. the content data). Until then, the application X server 14 completed its intended communication to the application X client 15. Therefore, the framework illustrated in FIG. 1 provides a framework and method for the application X server 14 to voluntarily initiate communications with the application X client 15.

The interaction of the components shown in FIG. 1 can be described as follows. The application X server 14 initializes communications by sending a message to the communication server 20. This message is intended for its specific client, e.g. application X client 15, which can include instructions for intended communications (i.e. data fetching) as well as other brief data. The message is meaningful to the application only. The communication framework does not need to understand the message. The communication server 20 stores the message in the message buffer 22 in order to respond to the communication client 21 polling request. If the application X server 14 has more data (e.g. control or instructional data) to send to the same client later, the application X server 14 will send the data to the communication server 20 again. The later message will be buffered together (i.e., concatenated) with the previous message if the previous message has not been sent out. Therefore, the concatenated message can be sent in response to a single polling request from the communication client 21. The “servlet” (e.g., the application X servlet 18 and the communication servlet 24) is not limited to just “servlets” or to current servlet technology. The “servlets” can be replaced by any other technologies (e.g., CGI programs) that perform a similar function.

At system starting time, the communication client 21 will send the first polling request to the communication server 20 via the communication servlet 24. Each application client must have a unique client ID, and the communication client 20 will use the client ID for polling. If there is message that is intended for the polling application client, the communication server 20 will send the message back via the communication servlet 24. After receiving the message, the communication client 21 parses the message. If the message is for application X, it sends the message to the application X client 15. Then, the communication client 21 polls again. The application X client 15 will send a request to the application X server 14 via application X servlet 18 based on the instructions received in the message. The application X server 14 responses with its intended application data. Then, the client/server two-way communications for application X is established. Details of the various components illustrated in FIG. 1 are described below.

FIG. 2 is a block diagram of a communication framework for multiple applications in an application server and multiple clients for the applications in an application client. FIG. 2 shows an application server 30 and an application client 32. The application server 30 includes the components for communication framework, i.e., communication server 20, message buffer 22, and communication servlet 24 which are the same as shown in FIG. 1. The application server 30 is shown with multiple applications including application A server 34 and application B server 36. In one example, the application A server runs “application A”, while application B server 36 runs “application B”. Note that while two application servers are shown, more could be included within the spirit and scope of the invention. The application A server 34 interacts with application A client 38 via application A servlet 40 using HTTP protocol. Similarly, the application B server 36 interacts with application B client 42 via application B servlet 44. In application client 32, the communication client 46 is behavior based (e.g., in Java script, Java applet, etc.) which can interact with the application A client 38 and application B client 42. Each application client 38 or 42 also has a behavior-based segment (e.g., in a hidden frame) for interaction with the communication client 46.

The communication framework shown in FIG. 2 operates in a manner similar to the communication framework shown in FIG. 1, with more applications involved. The invention allows the application A server 34 and the application B server 36 to voluntarily initiate communications with their respective clients. This is done by sending notification messages to their clients first via the communication framework, and letting their clients fetch the data from the servers instead of the servers sending data directly. For example, the application A server 34 can send a notification message to the communication server 20 which then stores the message in the message buffer 22. The message is intended to be sent to the application A client 38. Similarly, the application B server 36 can send a message to the communication server 20 which then stores the message in the message buffer 22. The message from the application B server 36 is intended to be sent to the application B client 42.

The communication client 46 is configured to poll the communication server 20 (via communication servlet 24) at system startup and after a received message is distributed. The purpose of the polling is to ensure that any new messages stored in the message buffer 22 be sent out. If the message buffer 22 contains any messages intended for the application client 32, the communication server 20 will retrieve the stored messages and send them to the communication client 46. Once the communication client 46 receives the messages, the messages are parsed and sent to the behavior based segment (e.g., Java script hidden frame) of the intended client. For example, if application A and Application B are in the same application server, and the clients for application A and Application B are in the same application client, as shown in FIG. 2, the message originated from the application A server 34 and the application B server 36 will be stored in the same buffer under the same client ID, and be retrieved by a single client polling. After being parsed, the appropriate data will be sent to the application A client 38 and the application B client 42. The data sent by the servers of the applications may include any desired type of data in addition to the notification for data fetching. For example, the data may relate to configuration, or brief data for client to present. In general, if the data is brief, a server of an application can send the data to its client via the communication framework directly, without letting the client fetch data from the server in another trip. It is the application's decision if it uses one trip or two for its server to client communication.

It should be understood that the communication framework of the present invention enables the control data path to be separated from each individual component's application data path. For example, in FIG. 2, the application data path for application A is illustrated by the lines between the application A server 34 and the application A servlets 40 and between the application A servlets 40 and the application A client 38. The application data path for application B is illustrated in the same way. The remaining connections shown illustrate the control data paths. This approach provides several advantages. First, control messages are brief. Therefore, the message parser will not be a bottleneck with an increased number of real-time applications. Second, the client/server for each component can still keep communication independence which can preserve componentization. The present invention provides several other advantages including: the enablement of client polling connection sharing and connection scaling for multiple applications under the same application server, the two-way HTTP communication service for multiple web clients, and the support of two-way HTTP communication services for multiple applications from multiple web sites.

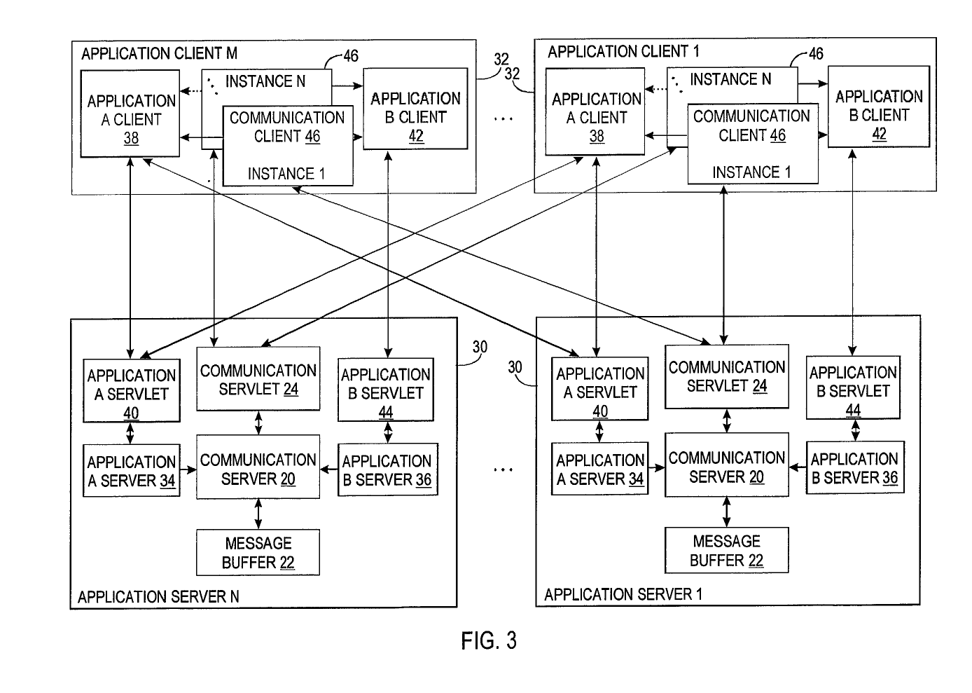

The communication framework of the present invention can be used in a multi-site environment by configuring the communication client to support multiple instances. FIG. 3 is a block diagram of a communications framework of the present invention in a multi-site environment. FIG. 3 shows a plurality of application servers 30 and a plurality of application clients 32. FIG. 3 shows N application servers 30 and M application clients 32, where N is the total number of application servers and M is the total number of application clients. The application servers 30 shown in FIG. 3 are substantially the same as the application server shown in FIG. 2. Each of the application servers 30 includes multiple server-side applications, e.g. application A server 34, application A servlets 40, application B server 36, application B servlets 44, as well as a communication server 20, a message buffer 22, and a communication servlet 24 as part of communication framework.

Each of the application clients 32 can include any combination of the clients for the involved applications. The application A client 38 and application B client 42 are shown as examples. The application clients shown in FIG. 3 are substantially similar to the application clients shown in FIG. 2. In order to communicate with communication servlets 24 from multiple sites, one communication client instance is necessary for each site. For example, this can be accomplished using a multiple hidden frame implementation for parallel multiple communication client polling sessions. The application clients 32 shown in FIG. 3 include N instances of communication clients 46.

The communication frameworks for the application servers and application clients shown in the multi-site environment of FIG. 3 function similarly to the ones shown in FIGS. 1 and 2. For example, assume that the application A server 34 in the N^{th} application server 30 wants to send data to the application A client 38 in the M^{th} application client 32. To do so, the application A server 34 would send a message to the communication server 20 and would indicate that this message is for application A in the M^{th} application client 32. For example, the message can be constructed as “Client ID: Application ID: message body”. The communication server 20 of the N^{th} application server then stores the messages in its message buffer 22. At system startup or during subsequent operations, the communication client 46 (instance N) in each application client will poll the communication server 20 of the N^{th} application server 30. In response to the polling, the communication server 20 of the N^{th} application server 30 will retrieve any stored messages in the message buffer 22 that are intended for the M^{th} application A client 38. The messages can be retrieved based on the Client ID. The retrieved messages will then be sent to the communication client 46 (instance N) of the Mₜₕ application client 32. The communication client 46 (instance N) of the M^{th} application client 32 will parse the message and send the appropriate data to the intended application A client 38 and others. This same procedure is followed for all of the applications in application servers 30 and their clients in application clients 32. It should be noted that an application X client only communicates to one application X server at a time, though the application X server can be located in different sites. A site can be considered as one logical application server in the clustering case. For example, in FIG. 3, the application A client 38 in the M^{th} application client 32 will communicate to an application A server 34 in one of the application servers (1 through N), but not to more than one at the same time.

Following are descriptions of one embodiment for the communication framework and their component implementation. The components will be described in the context of a web client/server implementation. It should be understood that the components described are merely examples and that the present invention may be implemented in a number of ways.

The communication client 46 may be implemented using Java script or Java applet, etc. As illustrated in FIG. 3, the communication client 46 may have multiple instances (e.g. multiple Java script hidden frames or multiple Java applet instances) for communication with multiple communication servlets and servers from the multiple sites. Each communication client 46 instance initiates polling requests to the appropriate communication servlet 24 upon system startup. As mentioned, the communication client 46 has a message parser which parses messages received from the communication servlet 24 and sends the parsed messages to the Java script hidden frames or Java applets in the corresponding clients of the applications. In one embodiment, the communication client 46 sends the next polling request immediately afterward. This is done recursively. In one embodiment, each communication client 46 includes its client ID when sending an HTTP polling request. The inclusion of the client ID insurers that the buffered messages match appropriately. The client ID should be able to uniquely identify an application client. In the example of a CRM environment, the client ID could be the client ID of an agent or a caller.

The communication servlet 24 is configured to receive the communication client 32 polling request. To respond to the request, the communication servlet 24 extracts the client ID from the polling request and calls the communication server 20 to retrieve buffered data corresponding to the client ID. The communication servlet 24 then sends back the buffered content to the requesting client. The polling requests from different communication clients 46 may share the same communication servlet 24 (i.e. use the same URL) for one application server 30 (see FIG. 3).

In one embodiment, the message buffer 22 is implemented using a hashtable in Java. In one example, the hashtable is a two-tier hashtable. In the two-tier hashtable example, the hashtable can include a buffer hashtable and a client hashtable. The buffer hashtable may include a name portion and a value portion, where the name portion contains the client ID and the value portion contains the client hashtable. The client hashtable also includes a name portion and a value portion, where the name portion contains the application ID and the value portion contains the concatenated message for the application's client. One advantage of using a hashtable is that the hashtable can resolve duplicated entries automatically, therefore insuring that there is one entry in the message buffer 22 for each application client, and one entry for each application in the client hashtable. Multiple messages from one application's server to its client can be combined in the value portion of the client hashtable entry. In this way, the message sent from the communication client 46 to each application's client can simply be the value portion of the client hashtable. This value can be a concatenation of data from multiple messages. Various techniques can be used to protect the integrity and consistency of the buffer data. Examples of some suitable techniques include lock or semaphore.

As mentioned, the communication server 20 receives messages from the servers of the applications and maintains the message buffer 22. The communication server 20 provides application program interfaces (API) for the applications' servers to send messages. For each buffered data retrieval request from the communication servlet 24, the communication server 20 will get a client hashtable from the buffer hashtable according to the client ID. If the client hashtable is not empty, the communication servlet 24 will serialize the hashtable content and send the data back to the communication client 46. Then, the communication server 20 will clear the buffer hashtable entry for this client ID. If the client hashtable is empty, the communication server 20 will wait for a period of time (ClientResponseInterval) for the buffer to be filled and then will get the data. If the client hashtable is still empty after waiting, empty data content will be sent back to the communication client 46. After the communication server 20 sends the client hashtable data, regardless of whether the data is empty or not, a timer is reset to a ClientTimeoutInterval. If there is no polling request from the client after the timer has elapsed, then the communication server 20 regards the client as “dead”, and the connection to this client will be terminated. The server checks the timer of ClientTimeoutInterval every ClientResponseInterval, when it would otherwise respond to the client's request.

After the Java script in the hidden frame (or Java applet, etc.) of each application's client receives messages from the communication client 46, it may fetch data from the application's server based on instructions in the messages. For each application's client (e.g., chat client, browser sharing client, etc.), the Java script hidden frame (or Java applet, etc.) can communicate to its servers in different sits by accepting server URL configuration (see FIG. 3).

As described above, an application's server can cause a message to be sent to a desired application client by sending a message to the communication server 20. The message initiated from an application's server should include a client ID identifying where the message should be sent. For example, for browser sharing or chat applications, the server of an application may want to send collaboration data to multiple participation clients. In this example, a sequence of messages can be sent where each message identifies one of the participation clients. In addition, each message will include the appropriate control data. When an application's server needs to send a message to a client via the message buffer 22, several steps are necessary to maintain a single entry in the message buffer for each client and for each application. When adding a message to the message buffer 22, the buffer hashtable should be checked to see if the client entry exists. If not, the client entry should be added. If the client entry exists, the current value from the buffer hashtable based on the client ID is accessed to get the client hashtable. Next, the client hashtable is checked to see if the application entry exists. If not the entry should be added. If the application entry exists, and the current value from the client hashtable based on the application ID is accessed to get the message string. The new message is then appended to the existing message string. The concatenated message is then stored back into the buffer.

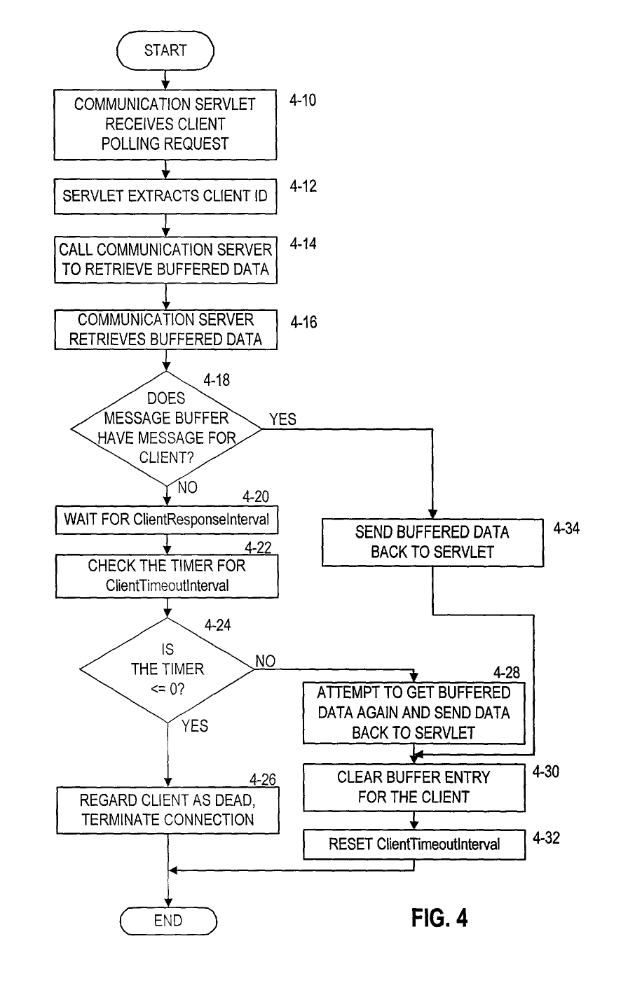

FIGS. 4-6 are flowcharts illustrating the operation of an embodiment of the invention. The flowcharts illustrate the process in different perspectives including from a server responding to client polling, from a server responding to a buffering request, and from a client. Note that the communication between the processes illustrated is asynchronized (i.e., each process is not really aware of the others).

FIG. 4 is a flowchart illustrating the process of a server responding to client polling. At step 4-10, the communication servlet 24 receives the client polling request from the communication client 46. Next, at step 4-12, the communication servlet 24 extracts the client ID from the polling request. The client ID uniquely identifies the polling application client. At step 4-14, the communication servlet 24 calls the communication server 20 to retrieve buffered data intended for the polling client. At step 4-16, the communication server 20 retrieves the buffered data from the message buffer 22. At step 4-18, the communication server 20 checks if the retrieved buffer data is empty. If it is empty, the process proceeds to step 4-20 where the communication server 20 waits for a period of time (ClientResponseInterval). Then, at step 4-22, the communication server 20 checks the timer for the ClientTimeoutInterval (described above). At step 4-24, the communication server 20 asks whether the timer is less than or equal to 0 (i.e. whether the ClientTimeoutInterval is elapsed). If so, the client is regarded as “dead”, and the connection is terminated and the process ends (step 4-26). If, at step 4-24, it is determined that the ClientTimeoutInterval has not passed, the process proceeds to step 4-28 where another attempt to get buffered data and send it back to the communication servlet 24. Next, at step 4-30 the buffer entry for the polling client is cleared, and at step 4-32, ClientTimeoutInterval is reset and the process ends.

If, at step 4-18, it is determined that the message buffer is not empty for the polling client, the process proceeds to step 4-34 where the data from the message buffer 22 is sent back to the communication servlet 24. The process then proceeds to step 4-30 the buffer entry for the polling client is cleared. The process then proceeds to step 4-32 where ClientTimeoutInterval is reset and the process ends.

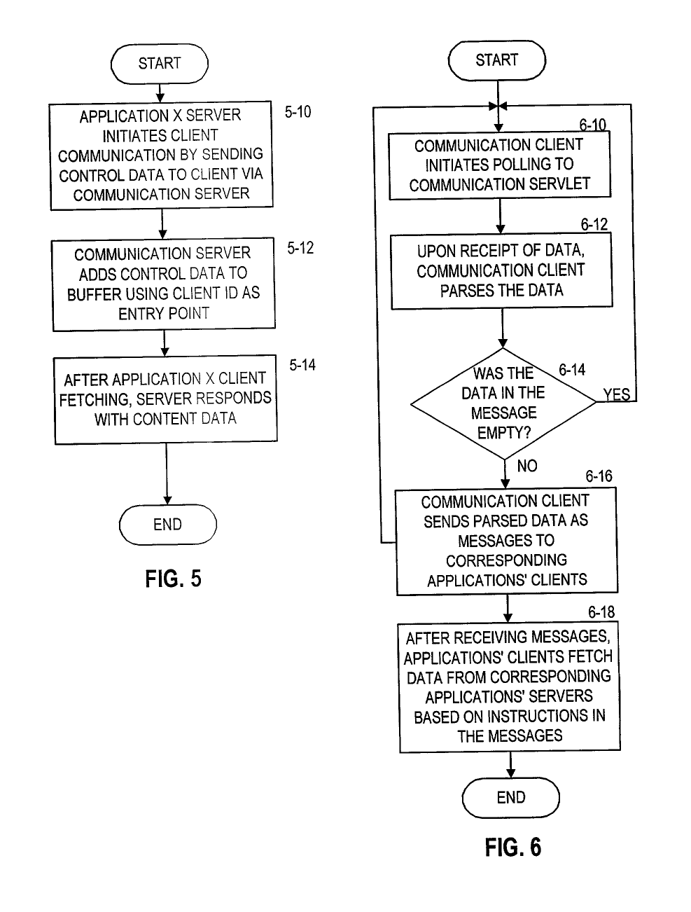

FIG. 5 is a flowchart illustrating the process of a communication server responding to a data buffering request from an application's server (i.e. application X server). At step 5-10, the application X server initiates communications with its client by sending control data to its client via the communication server 20. The communication server 20, using the client ID of the corresponding application client as the entry point, adds the control data sent from the application X server to the buffer 22 (step 5-12). After the intended application X client gets the message and fetches to the application X server, the application X server responds with the content data for the client/server communication (step 5-14).

FIG. 6 is a flowchart illustrating the processes of the clients' behaviors. At step 6-10 the communication client 46 initiates polling to the communication servlet 24. As mentioned above, the polling occurs at system startup and consecutive operations. Upon receipt of the buffered data, the communication client 46 parses the data (step 6-12). At step 6-14, the communication client 46 checks whether the data from the buffer is “empty”. If so, then the process proceeds back to step 6-10. If the data from the buffer is not “empty”, the process proceeds to step 6-16 where the communication client 46 sends the parsed data to the corresponding applications' clients. Note that there are two branches from step 6-16. A first branch proceeds to step 6-18 where, after receiving their intended messages, the applications' clients fetch data from the corresponding applications' servers based on the instructions in the parsed messages. A second branch proceeds from step 6-18 to step 6-10 where the communication client 46 starts the next polling. Note that after parsed messages are sent to the appropriate applications' clients, the messages are acted upon (the first branch) and, at the same time, the polling process starts over again (the second branch).

In the preceding detailed description, the invention is described with reference to specific exemplary embodiments thereof. Various modifications and changes may be made thereto without departing from the broader spirit and scope of the invention as set forth in the claims. The specification and drawings are, accordingly, to be regarded in an illustrative rather than a restrictive sense.

What is claimed is:

1. A method for facilitating server-initiated communications between one or more application servers and one or more application clients using HTTP protocol comprising the steps of:
providing a communication server for one or more server-side applications in an HTTP based application server;
wherein the communication server receives notification message data from one or more of the server-side applications, wherein the notification message data received by the communication server is intended for one or more clients of the applications, and wherein the notification message data includes application message data;
providing a communication client for one or more of the clients of applications in an HTTP based application client, wherein the communication client generates polling requests to the communications server;
in response to the polling requests from the communication client, sending any application message data to the communication client that is intended for any clients of applications in the HTTP based application client; and
upon receiving application message data, distributing the received application message data to the clients of applications.

2. The method of claim 1, wherein the communication client parses the received application message data and distributes parsed data messages to the intended clients of the applications, which may cause the clients of applications to fetch information from corresponding servers of the application.

3. The method of claim 1, further comprising the step of providing a communication servlet coupled between the communication server and the communication client.

4. The method of claim 1, further comprising the step of providing a message buffer for storing the data received by the communication server from the applications.

5. The method of claim 4, wherein the message buffer is comprised of a hashtable.

6. The method of claim 5, wherein the hashtable is a two-tier hashtable.

7. The method of claim 1, wherein the clients are web-based clients.

8. The method of claim 1, wherein the message data includes instructions for fetching data from corresponding servers of the applications.

9. The method of claim 1, wherein the message data is used for direct consummation.

10. A client/server communication framework for facilitating server-initiated communications to one or more clients using HTTP protocol comprising:
a first server in an application server for providing information to one or more clients using HTTP protocol;
a second server in the application server coupled to the first server for receiving a first message from the first server, wherein the first message is intended to be sent to a first client in an application client; and
a second client in the application client for sending an HTTP polling request to the second server, receiving the first message from the second server, and distributing the first message to the first client.

11. The client/server communication framework of claim 10, wherein the first server is a server for an application, the second server is a communication server, the first client is a client for the application, and the second client is a communication client.

12. The client/server communication framework of claim 10, further comprising a memory location for storing messages received by the second server.

13. The client/server communication framework of claim 12, wherein the messages are stored in a hashtable.

14. The client/server communication framework of claim 10, wherein the first message includes information identifying the first client and the application.

15. The client/server communication framework of claim 10, further comprising:
a third server for providing information to one or more clients using HTTP protocol, wherein the second server is coupled to the third server for receiving a second message from the third server, wherein the second message is intended to be sent to a third client using HTTP protocol; and
wherein the second message is sent to the third client in response to the same or consecutive polling requests by the second client.

16. The client/server communication framework of claim 10, wherein the first server is an application in a web server, and wherein the one or more clients are web-based clients.

17. The client/server communication framework of claim 10, wherein the first message is used to instruct the first client to fetch information from the first server using HTTP protocol.

18. The client/server communication framework of claim 10, wherein the first message is consumed by the first client directly.

19. A method for facilitating server-initiated communications from one or more servers to one or more clients under HTTP protocol comprising the step of:
providing a first server for communicating with one or more clients;
providing a second server for receiving a message from the first server, wherein the message includes information intended for a first client to fetch data from the first server;
providing a second client in the same application client of the first client for sending HTTP polling requests to the second server; and
upon receiving a polling request from the second client, sending the message from the second server to the second client; and
wherein the second client distributes the message to the first client.

20. The method of claim 19, further comprising the step of storing the message from the first server into a buffer.

21. The method of claim 20, wherein the buffer is provided by a hashtable.

22. The method of claim 19, wherein the first server is an application under a web server, and wherein the one or more clients are web clients.

23. The method of claim 19, wherein the communications between the servers and clients uses HTTP protocol.

24. The method of claim 19, wherein the first client fetches data from the first server in response to the message.

25. The method of claim 19, wherein the first client consumes the message directly.

26. The method of claim 19, further comprising the steps of:
providing a third server for communicating with one or more clients;
wherein the second server also receives a second message from the third server, wherein the second message includes information intended for a third client;
upon receiving a polling request from the second client, sending the information intended for the third client to the second client; and
distributing the message from the second client to the third client.
